(19) United States
(12) Patent Application Publication
(10) Pub. No.: US 2007/0221126 A1
(43) Pub. Date: Sep. 27, 2007

(54) Chemical Liquid Supply Apparatus

(75) Inventor: Takeo Yajima, Tokyo (JP)

Correspondence Address: MCCORMICK, PAULDING & HUBER LLP, CITY PLACE II, 185 ASYLUM STREET, HARTFORD, CT, 06103, US

(73) Assignee: Koganei Corporation, Tokyo (JP)

(21) Appl. No.: 10/593,607

(22) PCT Filed: Feb. 18, 2005
(86) PCT No.: PCT/JP05/02553

§ 371 Date: Sep. 21, 2006

(30) Foreign Application Priority Data
Mar. 23, 2004 (JP) 2004-083942

(51) Int. Cl. B05C 11/00

(52) U.S. Cl. 118/666; 118/710

(57) ABSTRACT

As shown in FIG. 3, a primary-side valve 13 and a secondary-side valve 14 are assembled in a nozzle assembly 12 on which a nozzle 11 for dispensing a chemical liquid is formed. The primary-side valve 13 is a valve for opening/closing a secondary-side flow path 14b communicating with the nozzle 11, whilst the secondary-side valve 14 is a valve for opening/closing an primary-side flow path 13b communicating with a connection port 18 that is open to the outside. A pump is provided between the primary-side valve 13 and the secondary-side valve 14. A double tube 21, having an internal tube 19 in which the chemical liquid flows and an external tube 20 in which temperature control water flows, is connected to the connection port 18. The chemical liquid kept at fixed temperature is sucked into a pump room 52 and is then dispensed from the nozzle 11.

### TECHNICAL FIELD

The present invention relates to a chemical liquid supply apparatus configured to dispense a liquid such as a chemical liquid per predetermined amount.

### BACKGROUND ART

In a manufacturing process such as a semiconductor wafer manufacturing technology, a liquid-crystal substrate manufacturing technology, a magnetic disk manufacturing technology, and a multi-layer printed circuit board manufacturing technology, a chemical liquid such as a photoresist liquid, a spin-on glass liquid, a polyimide resin liquid, pure water, an etching liquid, and an organic solvent is used. To dispense these chemical liquids, a chemical liquid supply apparatus is used.

For example, when a photoresist liquid is dispensed on a surface of a semiconductor wafer, a fixed amount of photoresist liquid is dropped by the chemical liquid supply apparatus onto the surface of the semiconductor wafer while the semiconductor wafer is being rotated in a horizontal plane. A pump sucking the photoresist liquid from a tank is disposed below the semiconductor wafer. The photoresist liquid sucked by the pump is dropped onto the semiconductor wafer through a tube on one end of which a nozzle is attached. To enable the nozzle to move between a dispensing position located at a center portion of the semiconductor wafer and a retreat position of not interfering with a mounting operation, the tube requires being disposed while being bent to some extent.

Since viscosity of the chemical liquid such as a photoresist liquid is varied due to liquid temperature, the temperature of the chemical liquid requires being kept constant in order to stabilize a dispensing state, particularly, film thickness. As a technology pertaining to adjustment of the temperature of the chemical liquid, there has been known thus far a technology in which a tube has a double-tube structure, wherein pure water whose temperature is adjusted is poured as temperature control water into an outside tube, that is, into an external tube and the temperature of the chemical liquid flowing in an inside tube, that is, in an internal tube is kept constant (for example, see Patent Document 1). In general, when the temperature of the chemical liquid is adjusted by the tube with a double-tube structure, length of the double tube requires being set to such an extent that, during dispensing of the chemical liquid, the amount of the chemical liquid to be dispensed from the nozzle at least at a time of next suction and dispensing can be adjusted within a range of desired temperature.

Patent Document 1: Japanese Patent Laid-Open Publication No. 2003-297788

### DISCLOSURE OF THE INVENTION

Recently, to save the chemical liquid such as a photoresist liquid and to improve yield of semiconductor device, further stabilization of a dispensing amount or flow rate has been demanded. To do so, resistance on a secondary side of the pump by which the fixed amount of chemical liquid is sucked/dispensed is preferably as small in size as possible and also stabilized as much as possible.

Meanwhile, the tube moving above the semiconductor wafer and attached on the nozzle requires being bent to some extent. If so, however, the tube is deformed whenever the nozzle moves. Therefore, the resistance on the secondary side of the pump becomes unstable. Moreover, a pump or tube formed of a resin for preventing a change in quality due to the chemical liquid is slightly deformed also by pressure of a liquid flowing therein, and further the pressure of the liquid is varied due to the viscosity of the liquid, so that the resistance on the secondary side becomes unstable whenever a kind of the chemical liquid is changed. Resetting of operation timing of the pump or various valves whenever the resistance on the secondary side of the pump is varied deteriorate operability.

An object of the present invention is to provide a chemical liquid supply apparatus for stabilizing its dispensing amount and flow rate.

A chemical liquid supply apparatus according to the present invention comprises a nozzle assembly including: a nozzle formed for dispensing a chemical liquid; a primary-side valve assembled for opening/closing a primary-side flow path communicating with a connection port opened to an outside; and a secondary-side valve assembled for opening/closing a secondary-side flow path communicating with the nozzle, wherein the chemical liquid is sucked into the nozzle assembly from the connection port by expanding a volume of a pump provided between the primary-side valve and the secondary-side valve, and the chemical liquid is dispensed to the outside of the nozzle assembly from the nozzle by shrinking the volume of the pump.

The chemical liquid supply apparatus according to the present invention is such that a double tube includes: an internal tube in which the chemical liquid sucked into the pump flows; and an external tube in which the internal tube is disposed and in which temperature control water for adjusting a temperature of the chemical liquid passing through the internal tube flows, the double tube being connected to the connection port.

The chemical liquid supply apparatus according to the present invention is such that a temperature control flow path, which communicates with the external tube and into which the temperature control water flows, is formed in the pump.

The chemical liquid supply apparatus according to the present invention is such that the pump is formed by a tube-shaped flexible film, one end of the flexible film communicating with the primary-side flow path and the other end thereof communicating with the secondary-side flow path and the pump sucking the chemical liquid by expansion of the flexible film and dispensing the chemical liquid by shrinkage of the flexible film.

The chemical liquid supply apparatus according to the present invention is such that the flexible film is accommodated in a driving room filled with a driving medium, the flexible film being expanded by decreasing a volume or pressure of the driving medium and the flexible film being shrunk by increasing the volume or pressure of the driving medium.

The chemical liquid supply apparatus according to the present invention is such that the nozzle assembly is fixed to a movable arm moving above a workpiece on which the chemical liquid is dispensed.

The chemical liquid supply apparatus according to the present invention is such that a driving device for increasing/decreasing the volume or pressure of the driving medium with which the driving room is filled is located at a portion other than the movable arm, and the driving device and the driving room are connected to each other via a tube in which the driving medium flows.

The chemical liquid supply apparatus according to the present invention is such that the driving medium is an incompressible medium, the flexible film is expanded by decreasing the volume of the incompressible medium in the driving room, and the flexible film is shrunk by increasing the volume of the incompressible medium.

According to the present invention, the double tube including the internal tube in which the chemical liquid flows and the external tube in which the temperature control water flows is connected on a primary side of the pump. Also, resistance on a secondary side of the pump is small and stabilized. Therefore, the predetermined amount of chemical liquid can be stably dispensed. It is possible to save trouble of resetting operation timing of the pump and various valves whenever the kind of the chemical liquid is changed, thereby improving operability.

According to the present invention, the pump for sucking/dispensing the chemical liquid is provided integrally with the nozzle assembly on which the nozzle is formed. The chemical liquid dispensed from the pump is dispensed from the nozzle without passing through the resistance-unstable tube. Therefore, the predetermined amount of chemical liquid can be stably dispensed. By fixing the nozzle assembly to the movable arm moving above the workpiece, the pump can be disposed immediately above the dispensing position.

According to the present invention, by forming the temperature control water flow path in which the temperature control water flows around an outer circumference of the pump room, the temperature of the chemical liquid in the pump room can be kept constant until a time immediately before dispensing. By forming the medium room filled with the driving medium for expanding/shrinking the pump room and the temperature control water flow path in which the temperature control water flows around the outer circumference of the pump room, the temperature of the driving medium can be kept constant. By keeping the temperature of the chemical liquid and that of the driving medium constant, the dispensing amount and flow rate of the chemical liquid is stabilized.

### BRIEF DESCRIPTION OF THE DRAWINGS

FIG. 1 is a fluid circuit diagram showing an outline of a chemical liquid supply apparatus according to one embodiment of the present invention;

FIG. 2 is an enlarged cross-section view of a coupling block to which a double tube is connected;

FIG. 3 is an enlarged cross-section view of the chemical liquid supply apparatus shown in the fluid circuit diagram of FIG. 1;

FIG. 4 is an enlarged cross-section view of a driving device shown in the fluid circuit diagram of FIG. 1;

FIG. 5 is a partially-omitted cross-section view showing a state of using the chemical liquid supply apparatus when the present invention is applied to, as one embodiment of the present invention, an apparatus for coating a semiconductor wafer with a photoresist liquid;

FIG. 6 is a partially-omitted cross-section view showing a chemical liquid supply apparatus according to another embodiment;

FIG. 7 is a partially-omitted cross-section view of a chemical liquid supply apparatus according to still another embodiment using a valve operated by air pressure and a magnetic force; and

FIG. 8 is a fluid circuit diagram showing an outline of a conventional chemical liquid supply apparatus.

### BEST MODE FOR CARRYING OUT THE INVENTION

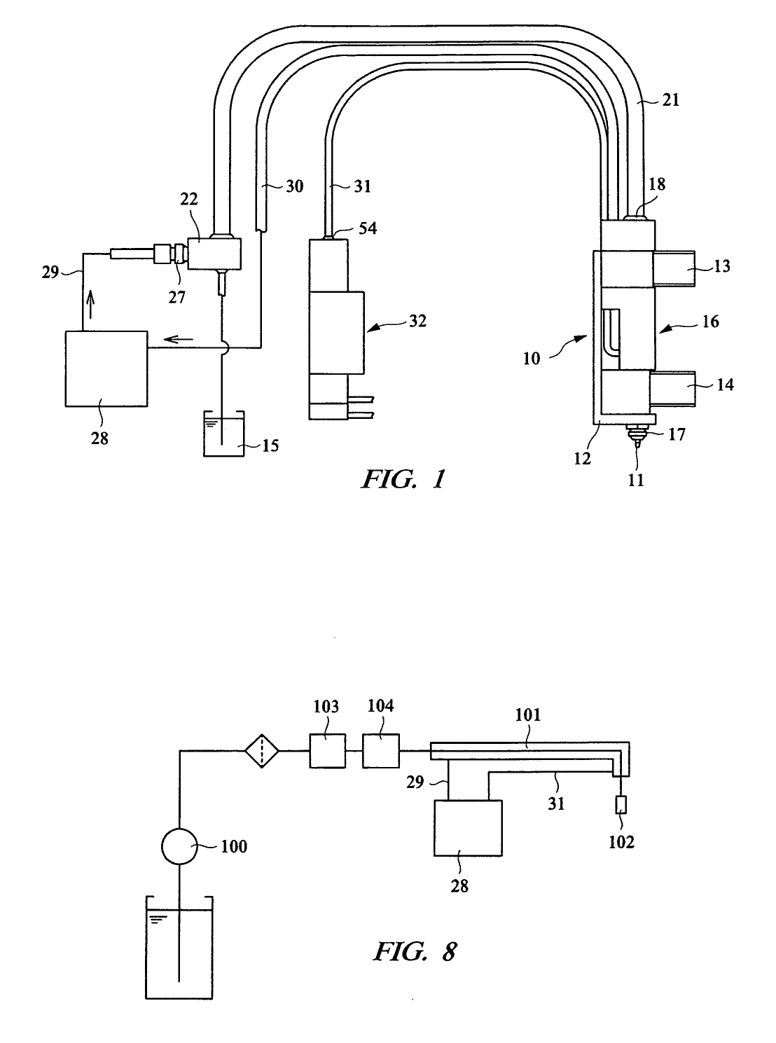

Hereinafter, embodiments of the present invention will be detailed on the basis of the accompanying drawings. FIG. 1 is a fluid circuit diagram showing an outline of a chemical liquid supply apparatus according to one embodiment of the present invention. A nozzle assembly 10 comprises: an approximately L-shaped nozzle holder 12 on which a nozzle 11 for dispensing a chemical liquid is formed; a primary-side valve 13 and a secondary-side valve 14 assembled in the nozzle holder 12; and a pump 16 provided between the primary-side valve 13 and the secondary-side valve 14 for sucking the chemical liquid accumulated in a chemical liquid tank 15 and dispensing it toward the nozzle 11.

A nozzle body 17 is disposed under the nozzle holder 12 so as to protrude therefrom. At a tip portion of the nozzle body 17, the nozzle 11 is open downward. On an upper side of the nozzle assembly 10, a connection port 18 is open upward. To the connection port 18, there is connected one end portion of a double tube 21 constituted by an internal tube 19 in which the chemical liquid sucked by the pump 16 flows and an external tube 20 in which the internal tube 19 is disposed. To the other end portion of the double tube 21, a coupling block 22 is connected. The internal tube 19 and the external tube 20 are branched inside the coupling block 22, wherein the internal tube 19 penetrates through the coupling block 22 and one end portion of the internal tube is disposed in the chemical liquid tank 15 and an end of the external tube 20 is connected to a penetration flow path 23 formed inside the coupling block 22.

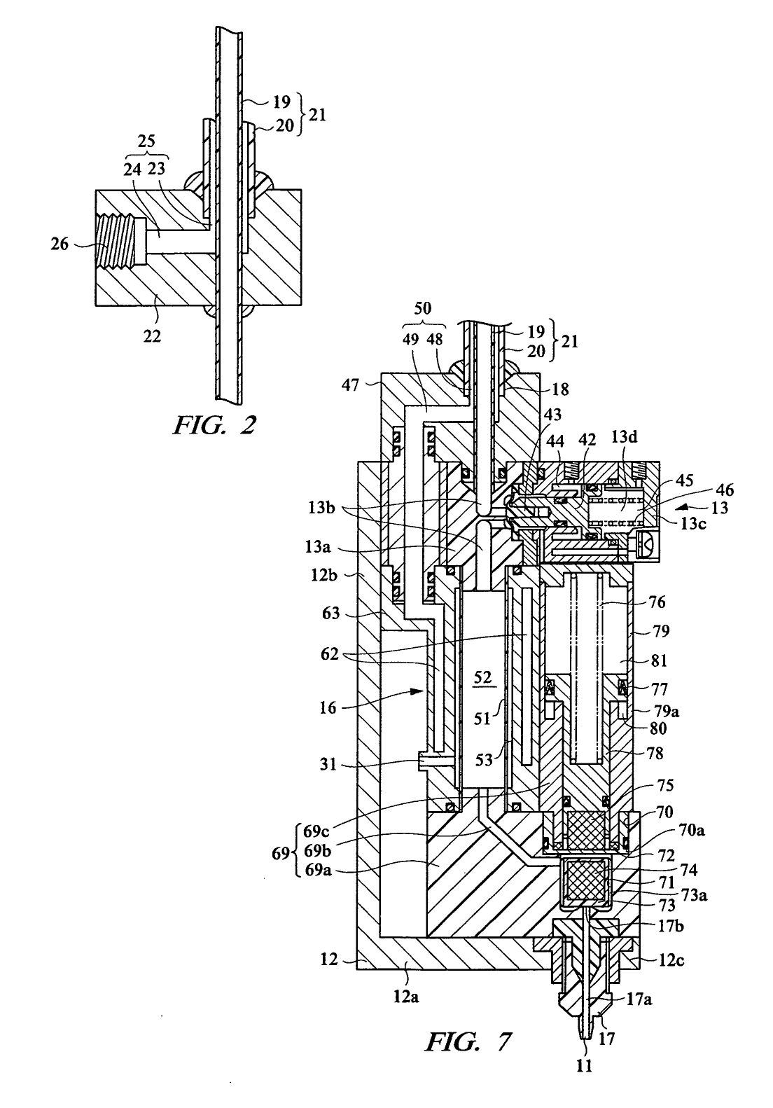

FIG. 2 is an enlarged cross-section view of the coupling block to which the double tube is connected. When being illustrated, a T-shaped flow path 25 is formed in the coupling block 22 and comprises the penetration flow path 23 penetrating through the coupling block 22 in one direction and a branch flow path 24 communicating with the penetration flow path 23 and extending toward a radial direction of the penetration flow path 23. The branch flow path 24 communicates with a linking port 26 that is open at a side surface of the coupling block 22. The internal tube 19 is disposed so as to penetrate through the penetration flow path 23. A female screw is formed in the linking port 26 so that a predetermined linking member 27 is screwed. As shown in FIG. 1, to the linking port 26, there is connected a tube 29 whose one end portion is provided with the linking member 27 and whose other end portion is connected to a temperature controller 28. Temperature control water temperature-controlled by the temperature controller 28 flows into the external tube 20 through the tube 29 and the T-shaped flow path 25.

The temperature control water is water for controlling the temperature of the chemical liquid before dispensing, and may be discarded after flowing out from the temperature controller 28. However, in the case shown in the drawing, the temperature control water flows back by using, as a return path, a tube 30 whose one end is connected to the nozzle assembly 10 and whose other end is connected to the temperature controller 28. As the temperature control water, a solution such as pure water is used. The temperature control water flowing into the temperature controller 28 is adjusted at predetermined temperature according to a kind of the chemical liquid by a heater incorporated and is then flows out. Note that a member into which the temperature control water flows, such as the external tube 20 or the tube 30 in which the temperature control water flows back, may be wrapped around by a thermal insulation material such as glass wool so as to enhance a heat retaining property. In the case shown in FIG. 1, a driving device 32 as described below is connected to the nozzle assembly 10 via a tube 31.

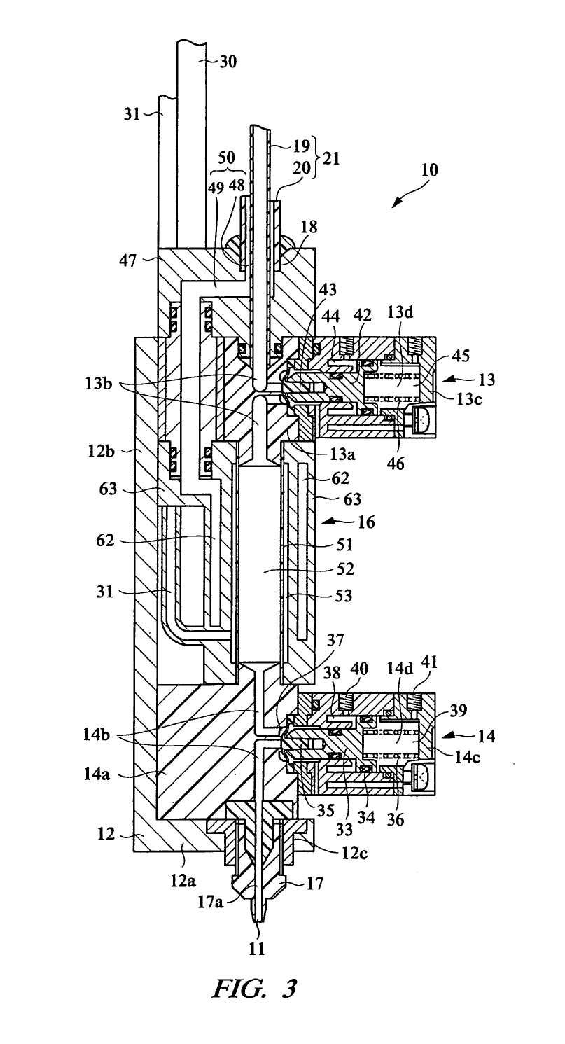

FIG. 3 is an enlarged cross-section view of the chemical liquid supply apparatus shown in the fluid circuit diagram of FIG. 1. The nozzle holder 12 is formed by assembling a bottom plate portion 12a and a side plate portion 12b into an approximately L shape. An attaching hole 12c for assembling the nozzle body 17 is formed in the bottom plate portion 12a so as to penetrate in a vertical direction. The nozzle body 17 in which a dispensing flow path 17a communicating with the nozzle 11 is formed along an axial direction is assembled in the attaching hole 12c.

In an upper portion of the nozzle body 17, that is, on the bottom plate portion 12a of the nozzle holder 12, a flow path portion 14a of the secondary-side valve 14 is assembled so as to abut on the side plate portion 12b. A secondary-side flow path 14b communicating with the nozzle 11 via the dispensing flow path 17a is formed in the flow path portion 14a. An accommodating chamber 14d is formed in an operating portion 14c constituting the secondary-side valve 14 so as to be integrally with the flow path portion 14a. A reciprocating body 33 for opening/closing the secondary-side flow path 14b is reciprocably accommodated in the accommodating chamber 14d.

The reciprocating body 33 slidably contacts with an inner circumferential surface of the chamber 14d via a V seal 34. A diaphragm 35 is mounted on one end portion of the reciprocating body 33 facing to the secondary-side flow path 14b, and an adjustable spring 36 is mounted on the other end portion thereof. The diaphragm 35 is formed of an elastic material. An outer edge of the diaphragm is sandwiched between the flow path portion 14a and the operating portion 14c and, in synchronization with movement of the reciprocating body 33, is elastically deformed at a position where the secondary-side flow path 14b is opened and at a position where it is closed.

The chamber 14d is partitioned and formed by the diaphragm 35 into a flow path opening/closing room 37 communicating with the secondary-side flow path 14b and an operating pressure chamber driving the reciprocating body 33. Further, the operating pressure chamber is partitioned and formed by the reciprocating body 33 into two operating pressure rooms 38 and 39. Supply/discharge ports 40 and 41 opening to the outside communicate with the operating pressure rooms 38 and 39, respectively. The reciprocating body 33 uses, as a driving force, air pressure supplied to the operating pressure room 38 and a biasing force of the adjustable spring 36, thereby causing the diaphragm 35 to operate at a position of opening the secondary-side flow path 14b and at a position of closing it. Note that the reciprocating body 33 may be driven by a difference in pressure between the operating pressure rooms 38 and 39 without providing the adjustable spring 36.

On an upper side of the secondary-side valve 14, a flow path portion 13a of the primary-side valve 13 is assembled to the side plate portion 12b of the nozzle holder 12. A primary-side flow path 13b communicating with the connection port 18 is formed in the flow path portion 13a. A chamber 13d is formed, integrally with the flow path portion 13a, in the operating portion 13c constituting the primary-side valve 13. A reciprocating body 42 for opening/closing the primary-side flow path 13b is reciprocably accommodated in the chamber 13d.

A structure of the operating portion 13c of the primary-side valve 13 is similar to that of the operating portion 14c of the secondary-side valve 14c. The reciprocating body 42 on which a diaphragm 43 is mounted uses, as a driving force, air pressure supplied to an operating pressure room 44 and a biasing force of the adjustable spring 46, thereby causing the diaphragm 43 to operate at a position of opening the primary-side flow path 13b and at a position of closing it. Note that the reciprocating body 42 may be driven by a difference in pressure between the operating pressure rooms 44 and 45 without providing the adjustable spring 46.

On an upper side of the primary-side valve 13, a coupling block 47 is assembled in the nozzle holder 12 via the primary-side valve 13. In the coupling block 47, there is formed a T-shaped flow path 50 constituted by a penetration flow path 48 penetrating through the coupling block 47 in one direction and a branch flow path 49 communicating with the penetration flow path 48 and extending toward a radial direction of the penetration flow path 48. The branch flow path 49 is formed so as to be bent at its tip and be open on a side surface located on a side abutting on the primary-side valve 13 like the penetration flow path 48. The internal tube 19 and the external tube 20 forming the double tube 21 is branched in the coupling block 47, wherein the internal tube 19 is disposed so as to penetrate through the coupling block 47 and an end of the internal tube communicates with the primary-side flow path 13b and wherein an end of the external tube 20 is connected to the branch flow path 49 formed in the coupling block 47. That is, the chemical liquid flowing in the internal tube 19 flows into the primary-side flow path 13b, and the temperature control water flowing in the external tube 20 flows into the branch flow path 49.

The pump 16 provided between the primary-side valve 13 and the secondary-side valve 14 is formed by a tube-shaped flexible film 51 whose one end communicates with the primary-side flow path 13b and whose other end communicates with the secondary-side flow path 14b. A pump room 52 is formed in the flexible film 51. When volume of the pump room 52 is expanded by elastically deforming the flexible film 51 outside, the chemical liquid is sucked into the pump room 52. When the volume of the pump room 52 is shrunk by elastically deforming the flexible film 51 inside, the chemical liquid is dispensed to the outside of the pump room 52

To elastically deform the flexible film 51, that is, to expand/shrink the pump room 52, in the case shown in FIG. 3, the flexible film 51 is accommodated in a driving room 53 filled with a driving medium and volume or pressure of the driving medium in the driving room 53 is repeatedly increased/decreased at predetermined timing. The flexible film 51 can be expanded by decreasing the volume or pressure of the driving medium filling the driving room 53, whilst the flexible film 51 can be shrunk by increasing the volume or pressure of the driving medium filling the driving room 53.

As the driving medium, positive pressure air or negative pressure air can be used. In particular, when the pump room 52 is expanded/shrunk by increasing/decreasing the volume of the driving medium, an incompressible medium can be used as the driving medium. A driving device for changing the volume or pressure of the driving medium is connected to the driving room 53. By way of example, the driving device 32 for changing the volume of the incompressible medium is connected to the driving room 53 via the tube 31.

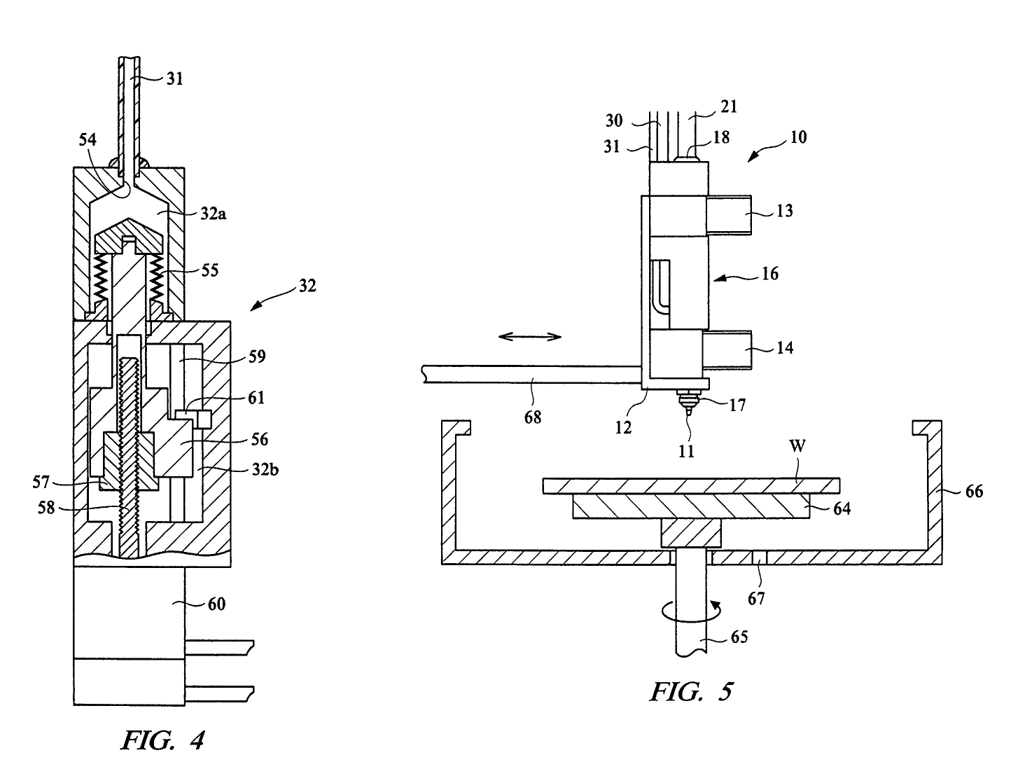

FIG. 4 is an enlarged cross-section view of the driving device shown in the fluid circuit diagram of FIG. 1. The driving device 32 has a medium room 32a filled with an incompressible medium, and an operating portion 32b for changing volume of the medium room 32a. A connection port 54 that is open to the outside is formed in the medium room 32a, and the tube 31 is connected to the connection port 54. When the volume of the incompressible medium in the medium room 32a is changed, the volume of the incompressible medium in the driving room 53 communicating via the tube 31 can be changed.

The medium room 32a is partitioned and formed by an accordion-shaped bellows 55 elastically deformable in an axial direction. Inside the bellows 55, a reciprocating body 56 whose one end portion is fixed to the bellows 55 is reciprocably disposed in an axial direction. A nut 57 is embedded in the other end portion of the reciprocating body 56 not fixed to the bellows 55. A feed screw 58 is screwed on the nut 57. On an outer circumferential surface of the reciprocating body 56, a rotation preventing member 59 is mounted. One end of the feed screw 58 is connected to a motor 60, thereby making it possible to reciprocate the reciprocating body 56 by driving the motor 60 in a forward or reverse direction.

In accordance with a reciprocating stroke of the reciprocating body 56, the volume of the medium room 32a is changed. When the reciprocating body 56 is driven forward, that is, in a direction in which the bellows 55 is extended, dispensing pressure of the chemical liquid occurs in the pump room 52. Conversely, when the reciprocating body 56 is driven backward, that is, in a direction in which the bellows 55 is shrunk, suction pressure of the chemical liquid occurs in the pump room 52. Note that as a means for reciprocating the reciprocating body 56, a fluid pressure cylinder such as a pneumatic cylinder or a hydraulic cylinder may be used. Also, a sensor 61 for detecting a stroke position of the reciprocating body 56 may be provided. In this case, the suction amount and the dispensing amount of the chemical liquid can be accurately controlled.

If positive pressure air or negative pressure air is used as a driving medium, a compressor, an ejector, or the like is connected as a driving medium to the driving room 53 via a switch valve. As the flexible film 51 accommodated in the driving room 53, a diaphragm or bellows may be used.

A temperature control water flow path 62 into which the temperature control water flows may be formed in the pump 16, whereby the temperature of the chemical liquid in the pump room 52 may be adjusted. In the case shown in FIG. 3, the temperature control water flow path 62 is formed in a pump forming body 63 partitioning and forming the driving room 53 so as to surround an outer circumference of the pump room 52. Into this temperature control water flow path 62, the temperature control water flowing in the external tube 20 flows via the branch flow path 49. The temperature control water flowing into the nozzle assembly 10 via the external tube 20 flows back to the temperature controller 28 by using the tube 30 as a return path.

FIG. 5 is a partially-omitted cross-section view showing a using state of the chemical liquid supply apparatus when the present invention is applied to, as one embodiment of the present invention, an apparatus for coating a semiconductor wafer with a photoresist liquid. When a photoresist liquid is dispensed on a semiconductor wafer W serving as a workpiece, a predetermined amount of photoresist liquid is dropped at a predetermined position on the semiconductor wafer W, for example, at a rotation center portion of the semiconductor wafer W while the semiconductor wafer W is being rotated in a horizontal plane.

The semiconductor wafer W is mounted on a disk-shaped rotating body 64. The rotating body 64 is fixed to a rotating shaft 65 rotatably driven by a driving unit not shown such as a motor. In order to prevent the chemical liquid dispensed on the semiconductor wafer W from spattering peripherally by a centrifugal force, a cup 66 is disposed for accommodating the semiconductor wafer W and the rotating body 64. On a bottom plate portion of the cup 66, a waste liquid path 67 for collecting the spattered chemical liquid is formed.

A movable arm 68 is disposed above the semiconductor wafer W. The nozzle holder 12 is fixed to one end portion of the movable arm 68. The movable arm 68 moves between a dispensing position where the nozzle 11 formed on the nozzle assembly 10 is set immediately above a dispensing position and a retreat position of not interfering with a mounting operation of the semiconductor wafer W. The chemical liquid tank 15, the temperature controller 28, and the driving device 32 are each connected to the nozzle assembly 10 via the double tube 21, the tubes 30 and 31, and the coupling block 22. As described above, since the movable arm 68 moves between the dispensing position and the retreat position, the double tube 21 and the tubes 30 and 31 are disposed while being bent to some extent so as not to interfere with the movement of the arm. Furthermore, length of the double tube 21 is also considered and set so that, during the dispensing of the chemical liquid, the chemical liquid subjected to at least the next suction/dispensing operation can be adjusted within a range of desired temperature.

Meanwhile, when the chemical liquid accommodated in the chemical liquid tank 15 is a photoresist liquid, members in which the chemical liquid flows such as the internal tube 19, the flexible film 51, and the nozzle body 17 are made of a fluoroethylene perfluoroalkyl vinyl ether copolymer (PFA), which is a fluoro resin, so as not to react with the chemical liquid. However, the resin material is not limited to a PFA, and as long as the material is elastically deformed, another resin material or metal material may be used.

Next, an operation of the chemical liquid supply apparatus will be described when the chemical liquid is dispensed on the semiconductor wafer W.

To suck the chemical liquid into the pump room 52, the reciprocating body 42 of the primary-side valve 13 is operated at a position where the primary-side flow path 13b is caused to open, and also the reciprocating body 33 of the secondary-side valve 14 is operated at a position where the secondary-side flow path 14b is caused to close. Next, by moving the reciprocating body 56 of the driving device 32 backward to expand the pump room 52, the predetermined amount of the chemical liquid present in the internal tube 19 is sucked into the pump room 52. As described above, the length of the double tube 21 is set to such an extent that the chemical liquid dispensed from the nozzle at a time of the next suction/dispensing can be adjusted within a range of the desired temperature. The temperature control water for keeping the temperature of the chemical liquid constant flows in the external tube 20. Therefore, the temperature of the chemical liquid sucked into the pump room 52 is always constant. In addition, the temperature of the chemical liquid having been sucked into the pump room 52 is also kept constant by the temperature control water flowing in the temperature control water flow path 62.

To dispense the chemical liquid to the outside of the pump room 52, the reciprocating body 42 of the primary-side valve 13 is operated at a position where the primary-side flow path 13b is caused to close and also the reciprocating body 33 of the secondary-side valve 14 is operated at a position where the secondary-side flow path 14b is caused to open. Next, by moving the reciprocating body 56 of the driving device 32 forward to shrink the pump room 52, the chemical liquid present in the pump room 52 can be dispensed from the nozzle 11.

When the chemical liquid is dispensed from the nozzle 11, the nozzle body 17 is placed at the dispensing position. After completion of dispensing the chemical liquid on the semiconductor wafer W, the nozzle body 17 is moved to the retreat position. As described above, the nozzle body 17 on which the nozzle 11 is formed is provided immediately after the secondary-side valve 14 of the pump 16, so that the resistance on the secondary side of the pump 16 into/from which the fixed amount of chemical liquid is sucked/dispensed is made small and stabile. Thereby, the chemical liquid can be stably dispensed on the semiconductor wafer W per fixed amount.

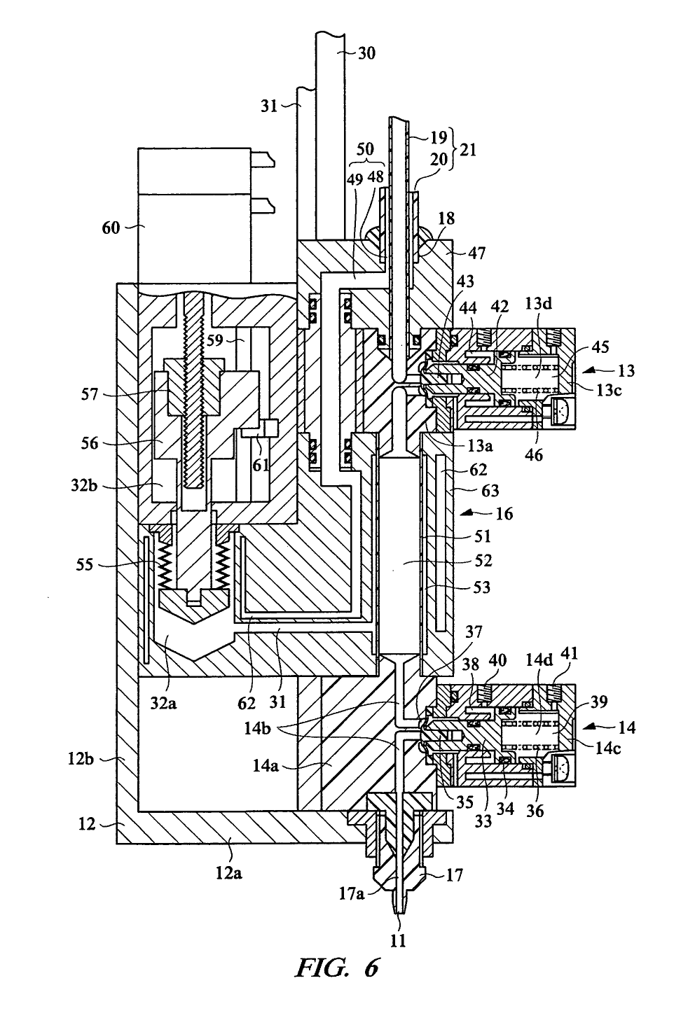

Meanwhile, the pump 16 serving as a driven side with respect to the driving device 32 and the driving device 32 serving as a driving side may be integrally configured. FIG. 6 is a partially-omitted cross-section view of a chemical liquid supply apparatus according to another embodiment. Note that the same members as those shown in FIGS. 3 and 4 are denoted by the same reference numerals. In the case shown in the drawing, the driving device 32 shown in FIG. 4 is assembled in the nozzle holder 12 and each of the primary-side valve 13 and the secondary-side valve 14 is assembled in the nozzle holder 12 via the driving device 32. The temperature control water flow path 62 formed on the outer circumference of the pump room 52 is provided so as to extend to the outer circumference of the driving room 53, thereby making it possible to keep the temperature of the driving medium constant. By suppressing a change in temperature of the driving medium, dispensing accuracy of the pump 16 can be enhanced. Also, by way of another example of integral formation, a driving scheme disclosed in Japanese Patent Laid-Open Publication No. 10-61558 can also be used to expand/shrink the pump room 52.

Also, the primary-side valve 13 and the secondary-side valve 14 are each not limited to an air-operated valve operated by air pressure as shown in FIGS. 1 through 6, and may use a solenoid valve operated by an electric signal, a check valve, or other valves. FIG. 7 is a partially-omitted cross-section view of a chemical liquid supply apparatus according to another embodiment using a valve operated by air pressure and a magnetic force. Note that the same members as those shown in FIG. 3 are denoted by the same reference numerals.

On the lower portion of the nozzle holder 12, that is, on the bottom plate portion 12a of the nozzle holder 12, a flow path portion 69a of an alternative valve 69 operated by air pressure and a magnetic force is assembled instead of the secondary-side valve 14 operated by air pressure. An interior of the resin-made flow path portion 69a is provided with a large-diameter room 70 formed so as to be open upward and a small-diameter room 71 formed so as to be open to a bottom portion of the large-diameter room 70. A bottom portion of the small-diameter room 71 is provided with a dispensing port 17b communicating with the dispensing flow path 17a, and a secondary-side flow path 69b communicating with the pump room 52 is open to an inner circumferential surface of the small-diameter room 71, whereby the chemical liquid sucked into the pump room 52 flows into the small-diameter room 71.

The small-diameter room 71 and the large-diameter room 70 are partitioned and formed by a sealing member 70a with a concave cross-section fitted in the large-diameter room 70. A ring-shaped absorbing plate 72 is fitted inside the sealing member 70a. A reciprocating body 73 slidably contacting with an inner circumferential surface of the small-diameter room 71 is accommodated in the small-diameter room 71. The reciprocating body 73 is operated at a position of abutting on the sealing member 70a to cause the dispensing port 17b to open and at a position of abutting on a bottom portion of the small-diameter room 71 to cause the dispensing port 17b to close. An outer circumferential surface of the reciprocating body 73 is provided with a plurality of grooves 73a along an axial direction. When the reciprocating body 73 is operated at the position of opening the dispensing port 17b, the chemical liquid present in the secondary-side flow path 69b flows into the dispensing flow path 17a via the grooves 73a.

A permanent magnet 74 is embedded in the reciprocating body 73 so that magnetic domains are formed on upper and lower sides thereof, for example, an N pole is formed on the upper side and an S pole is formed on the lower side. Since the permanent magnet 74 is attracted to the absorbing plate 72 serving as a magnetic material, the reciprocating body 73 is operated at the position of opening the dispensing port 17b.

In the large-diameter room 70 in which the absorbing plate 72 is fitted, an operating portion 69c constituting the alternative valve 69 integrally with the flow path portion 69a is assembled. The operating portion 69c has: a reciprocating body 78 on whose one end a permanent magnet 75 is mounted and on whose other end an adjustable spring 76 is mounted and on whose side surface portion a seal member 77 is mounted; and a cylinder member 79 reciprocably accommodating the reciprocating body 78.

An interior of the cylinder member 79 is partitioned and formed into two operating pressure rooms 80 and 81 by the reciprocating body 78. A supply/discharge port 79a open to the outside communicates with the operating pressure room 80 in which the adjustable spring 76 is not accommodated. The reciprocating body 78 uses, as a driving force, air pressure supplied to the operating pressure room 80 and a biasing force of the adjustable spring 76, whereby the permanent magnet 75 mounted on the reciprocating body 78 is caused to operate in a direction of approaching the reciprocating body 73 accommodated in the small-diameter room 71 and in a direction of separating therefrom. As the permanent magnet 75 is mounted on the reciprocating body 78, the magnetic domains are disposed in a direction repulsive to the permanent magnet 74 embedded in the reciprocating body 73 by, for example, an S pole being disposed on an upper side and an N pole being disposed on a lower side. Therefore, if the reciprocating body 78 is forcefully brought near the reciprocating body 73, the permanent magnets 74 and 75 are repulsive to each other, whereby the reciprocating body 73 is caused to operate in a direction of separating from the reciprocating body 78.

In such an alternative valve 69, when the adjustable spring 76 is compressed by the air pressure supplied to the operating pressure room 80 and causes the reciprocating body 78 to operate in the direction of separating from the reciprocating body 73, the reciprocating body 73 in which the permanent magnet 74 is embedded is attracted to the absorbing plate 72 and causes the dispensing port 17b to be open, whereby the secondary-side flow path 69b and the dispensing flow path 17a communicate with each other and the chemical liquid in the pump room 52 and the small-diameter room 71 is dispensed from the nozzle 11. On the other hand, when the supply of air pressure to the operating pressure room 80 is stopped, the reciprocating body 78 is operated in the direction of approaching the reciprocating body 73 by the biasing force of the adjustable spring 76. Therefore, the reciprocating body 73 is repulsive thereto and causes the dispensing port 17b to be close, thereby blocking communication between the secondary-side flow path 69b and the dispensing flow path 17a.

FIG. 8 is a fluid circuit diagram showing an outline of a conventional chemical liquid supply apparatus. Conventionally, a double-structure tube 101 is disposed on a secondary side of a pump 100, and temperature control of a chemical liquid is performed by using the temperature controller 28. In this case, the double-structure tube 101 with predetermined length or longer has been used in view of ensuring a temperature adjusting range of the chemical liquid and a movable range of a nozzle 102. However, since the resin-made tube is bent due to the pressure of the chemical liquid or the movement of the nozzle 102, problems arise so that the resistance on the secondary side is not stable and also the dispensing amount and the flow rate of the chemical liquid are not stable. Furthermore, since the pressure of the chemical liquid is varied with the viscosity of the chemical liquid, operation timing of the pump 100, an open/close valve 103, and a suck-back valve 104 requires being reset whenever the kind of the chemical liquid is changed, so that operability has deteriorated.

The present invention is not limited to the above embodiments, and can be variously modified within the scope of not departing from the gist thereof. For example, in order to prevent dripping of the chemical liquid from the nozzle 11 after dispensing the predetermined amount of chemical liquid from the nozzle 11, a suck-back operation may be required. In such a case, when the pump room 52 is expanded with the primary-side valve 13 being closed and the secondary-side valve 14 (alternative valve 69) being opened, the chemical liquids remaining in the dispensing flow path 17a and the secondary-side flow paths 14b and 69b are sucked into the pump room 52, whereby dripping from the nozzle 11 can be prevented. However, in the case of causing the suck-back operation to be performed, a check valve cannot be used as a secondary-side valve.

The nozzle holder 12 does not require being formed into an approximately L shape. Furthermore, use of the nozzle holder 12 may be omitted by constituting the nozzle assembly 10, in which the primary-side valve 13 and the secondary-side valve 14 are assembled with respect to the pump forming body 63 and the nozzle body 17 on which the nozzle 11 is formed is assembled with respect to the secondary-side valve 14. A filter may be disposed between the chemical liquid tank 15 and the coupling block 22 for removing foreign substances such as dust and drain flowing in the internal tube 19. As an incompressible medium, powder or particles may be used instead of a liquid.

### INDUSTRIAL APPLICABILITY

This chemical liquid supply apparatus can be used to dispense a chemical liquid such as a photoresist liquid, a spin-on glass liquid, a polyimide resin liquid, pure water, an etching liquid, and an organic solvent in a semiconductor wafer manufacturing technology, a liquid-crystal substrate manufacturing technology, a magnetic disk manufacturing technology, and a multi-layer printed circuit board manufacturing technology.

1. A chemical liquid supply apparatus comprising a nozzle assembly including: a nozzle formed for dispensing a chemical liquid; a primary-side valve assembled for opening/closing a primary-side flow path communicating with a connection port opened to an outside; and a secondary-side valve assembled for opening/closing a secondary-side flow path communicating with the nozzle,
wherein the chemical liquid is sucked into the nozzle assembly from the connection port by expanding a volume of a pump provided between the primary-side valve and the secondary-side valve, and the chemical liquid is dispensed to the outside of the nozzle assembly from the nozzle by shrinking the volume of the pump.

2. The chemical liquid supply apparatus according to claim 1, wherein a double tube includes: an internal tube in which the chemical liquid sucked into the pump flows; and an external tube in which the internal tube is disposed and in which temperature control water for adjusting a temperature of the chemical liquid passing through the internal tube flows, the double tube being connected to the connection port.

3. The chemical liquid supply apparatus according to claim 2, wherein a temperature control flow path, which communicates with the external tube and into which the temperature control water flows, is formed in the pump.

4. The chemical liquid supply apparatus according to claim 3, wherein the pump is formed by a tube-shaped flexible film, one end of the flexible film communicating with the primary-side flow path and the other end thereof communicating with the secondary-side flow path and the pump sucking the chemical liquid by expansion of the flexible film and dispensing the chemical liquid by shrinkage of the flexible film.

5. The chemical liquid supply apparatus according to claim 4, wherein the flexible film is accommodated in a driving room filled with a driving medium, the flexible film being expanded by decreasing a volume or pressure of the driving medium and the flexible film being shrunk by increasing the volume or pressure of the driving medium.

6. The chemical liquid supply apparatus according to claim 5, wherein the nozzle assembly is fixed to a movable arm moving above a workpiece on which the chemical liquid is dispensed.

7. The chemical liquid supply apparatus according to claim 6, wherein a driving device for increasing/decreasing the volume or pressure of the driving medium with which the driving room is filled is located at a portion other than the movable arm, and the driving device and the driving room are connected to each other via a tube in which the driving medium flows.

8. The chemical liquid supply apparatus according to claim 7, wherein the driving medium is an incompressible medium, the flexible film is expanded by decreasing the volume of the incompressible medium in the driving room, and the flexible film is shrunk by increasing the volume of the incompressible medium.
